(19) United States
(12) Patent Application Publication
(10) Pub. No.: US 2026/0262150 A1
(43) Pub. Date: Sep. 3, 2026

(54) EFFICIENCY OPTIMIZATION BY PARALLEL STRING SWITCHING THROUGH DIMMING INTERFACE

(71) Applicant: SIGNIFY HOLDING B.V., EINDHOVEN (NL)

(72) Inventors: KARNEKUMAR ARULANDU, BREDA (NL); HAIMIN TAO, EINDHOVEN (NL); FRANCISCUS JACOBUS VOSSEN, HELMOND (NL); BEREND JAN WILLEM TER WEEME, EINDHOVEN (NL)

(21) Appl. No.: 19/165,164

(22) PCT Filed: Mar. 11, 2024
(86) PCT No.: PCT/EP2024/056335

§ 371 Date: Sep. 15, 2025

(30) Foreign Application Priority Data
Mar. 16, 2023 (EP) 23162246.5

(51) Int. Cl. H05B 45/46; H05B 45/10

(52) U.S. Cl. CPC H05B 45/46; H05B 45/10

(57) ABSTRACT

The invention relates to a driver circuit for driving a plurality of light sources. The driver circuit comprises a driver adapted to provide a first current to a first light source and a second current to a second light source, a controller for controlling the driver. The controller is arranged to receive a dimming signal indicative of a dimming level for a light output of the light sources. The controller is arranged to convert the received dimming signal into a discrete number of dimming levels representing dimming levels. The discrete dimming levels corresponds to an amount of current that is to be provided by the driver to the first light source and/or the second light source. At a first discrete dimming level, the controller is arranged to allow the first current to the first light source to be provided and prevents the second current to be provided to the second light source. At a second discrete dimming level, the controller is arranged to allow the first current to be provided to the first light source and the second current to be provided to the second light source.

### FIELD OF THE INVENTION

The invention relates to driver circuit. The invention further relates to a lighting device.

### BACKGROUND OF THE INVENTION

For the lighting industry, the requirements for energy efficiency become more challenging, especially with the new European Union energy labelling introduced on 1 Sep. 2021. This new labelling follows the trend of improvements in energy efficiency for lighting products. By then, more and more light sources achieved label ratings of A+ or A++, making it impossible for customers to see any light efficiency difference between products. With the new labelling, the light sources become more distributed over the labelling range again. This also means that lamps that were for example A++ rated in the old system are now labelled as C. It is therefore desired to further improve the energy efficiency of light sources.

Especially at dimmable light sources, there is a great desire to improve the efficiency. At dimming and especially deep dimming, the fixed losses in a driver e.g., losses caused in the control circuit, become a dominant part of the losses in a lighting apparatus.

Drivers are generally designed for their rated power and the fixed losses are therefore also depending on the rated power of the driver. In general, a driver with a lower rated output power has also lower fixed power losses. This obviously impacts the total amount of power that can be provided to the load. A driver with a higher rated power can provide more power to its output, but this comes with more fixed losses. It is therefore desired to provide a lighting apparatus that can provide a good dimming function while operating at a very high efficiency.

### SUMMARY OF THE INVENTION

It is an objective of the invention to provide a solution that allows dimming to be performed while maintaining a good overall efficiency.

To provide such solution, in a first aspect of the invention, a driver circuit for driving a plurality of light sources is provided. The driver circuit comprises:
a driver adapted to provide a first current to a first light source and a second current to a second light source;
a controller for controlling the driver;
wherein the controller is arranged to receive a dimming signal indicative of a dimming level for a light output of the light sources,
wherein the controller is arranged to convert the received dimming signal into a discrete number of dimming levels representing dimming levels, wherein the discrete dimming levels corresponds to an amount of current that is to be provided by the driver to the first light source and/or the second light source, wherein:
at a first discrete dimming level, the controller is arranged to allow the first current to be provided to the first light source and prevents the second current to be provided to the second light source;
at a second discrete dimming level, the controller is arranged to allow the first current to be provided to the first light source and the second current to be provided to the second light source.

A driver is provided that can provide a regulated current to multiple light sources. A first light source and a second light source are capable of receiving a current from the driver. A controller is provided to receive a dimming signal and provide a discrete dimming level. Examples of dimming signals are phase-cut dimming signals, 0-10 V dimming signals, DALI dimming signals, DMX dimming signals or wireless dimming signals. The controller translates the received dimming signal into a number of discrete dimming levels. The discrete dimming levels are used to determine the amount of current that is to be provided to the first light source and/or second light source.

Absolute maximum efficiency of the LED is achieved at a specific current density i.e., beyond and below this current density efficiency deteriorates. It is an insight of the inventors that current density of LEDs needs to be optimized for the entire dimming range in order to have maximum efficiency over dimming range. The invention provides the optimal current density by switching off LEDs at lower dimming levels. To provide switch off events, discrete dimming levels are introduced. The discrete dimming levels may be used to provide a level at where a change in active light sources may be provided.

A first discrete dimming level may be a low dimming level. At this dimming level, a low amount of light output is required. The controller may be used to allow the driver to provide the first current to the first light source and prevents the second current to be provided to the second light source. The driver does not need to provide the additional second current, and maintain the first current only through the first light source. The total current provided by the driver is lowered, while also the total amount of light source that remain active is lowered. The current density in the first light source is not affected by the disconnection of the second light source or removal of the second current. The driver therefore provides a lower current to the light sources, effectively reducing the light output of the light sources, while maintaining a high current density in the active light sources.

A second discrete dimming level may be a high diming level. At this dimming level, a high amount of light output is required. The controller may be used to allow the driver to provide the first current to the first light source and the second current to the second light source. The driver provides the first current and the second current. The total current provided by the driver is therefore increased, while also the total amount of light sources is increased. The current density in the first light source is not affected by the introduction of the second light source and the second current. The increase of current results in that the light sources will provide more light, while maintaining a good efficiency.

Preferably, the driver can only provide steady currents corresponding to the current levels set at the discrete dimming levels. In this way, the current density in the first light source and/or the second light source may remain constant and at a level that allows the light source to emit light at a high efficiency.

In a further example, at a third discrete dimming level, the controller is arranged to prevent the first current to be provided to the first light source and arranged to provide the second current to the second light source.

Another discrete dimming level may be provided where the driver provides the second current to the second light source but no current to the first light source. This allows the controller to determine based on the dimming level provided to change between powering only the first light source, powering only the second light source and powering both the first light source and the second light source. There may be many benefits for powering only the first light source or only the second light source, as will be explained later.

In a further example, between two discrete dimming steps, the driver is arranged to provide a variable current to only one of the first light source or the second light source based on the dimming signal, while maintaining the current through the other of the first light source or the second light source constant.

It is preferred that in between two discrete dimming levels, only one light source may provide a varying current from the driver. This could mean that e.g. the driver provides a fixed current to the first light source, preferably at the optimum current density of the first light source. Preferably, the driver may then additionally provide a current to the second light source that may vary based on the dimming signal. By providing a fixed current to the first light source, preferably at the optimum current density of the first light source, the first light source operates at the highest efficiency. The second light source may operate at an efficiency that may be lower. The overall efficiency is however still improved, while variable current in the second light source allows for more dimming levels. Between two discrete dimming levels, the controller can provide additional dimming levels, which allows the driver that provides the variable power to the light source to change its output power according to the dimming signal.

In a further example a lighting device is provided. The lighting device comprises:
the driver circuit;
the first light source, and
the second light source.

The lighting device benefits most from the invention since the overall efficiency of the lighting device is improves, mainly by providing currents to the light sources that allow more efficient light emission.

Preferably, the light sources are semiconductor light sources. Examples of semiconductor light sources are LEDs, laser diodes and vertical-cavity surface-emitting lasers, VCSEL. Preferably, the LEDs are formed as a filament.

In a further example, the first light source and the second light source are coupled in a parallel configuration.

Preferably, the first light source and the second light source are coupled in parallel. This allows the driver to provide an easy control and distribution of currents between the first light source and the second light source.

In a further example, the driver circuit comprises a first switch coupled in series with the second light source, wherein the controller is arranged to open and close the first switch and wherein the first current flows through the first light source when the first switch is open and wherein the second current flows through the second light source when the first switch is closed.

As a very easy way to regulate the current through the first light source and the second light source, a first switch is coupled is series with the second light source. When the first switch is open, a current path through the second light source is blocked and therefore current can only flow through the first light source. The opening of the first switch can therefore be used at the first discrete dimming level to allow the driver to provide the first current to the first light source and prevents the second current to be provided to the second light source. When the first switch is closed, the second current can flow through the second light source. In addition, the first current may still flow through the first light source. The closing of the first switch can therefore be used at the second discrete dimming level to allow the driver to provide the first current to the first light source and the second current to the second light source. In this example, it is preferred that the first light source and the second light source have approximately identical forward voltages.

In a further example, the driver circuit comprises a first switch coupled in series with the first light source and a second switch coupled in series with the second light source, wherein the controller is arranged to open and close the first switch and the second switch, wherein the first current flows through the first light source when the first switch is closed and wherein the second current flows through the second light source when the second switch is closed.

In this example, both light sources are coupled in series with a respective switch. Closing the respective switch causes the respective light source to be active. If the first switch is closed, the first current will flow through the first light source. If the second switch is closed, the second current will flow thorough the second light source. If both switches are closed, depending on the configuration of the light sources, the first current may flow through the first light source and the second current may flow thorough the second light source. If both switches are open, no current can flow through either light source. This may cause a risk if the driver provides a current. An additional switch may be provided to shunt all light sources. The current from the driver now has a current path, which does not pass through any light source. Alternatively, the driver can be set to generate no current when both switches are open. Preferably, in any event, one of the two switches is closed so that a current path for the driver is guaranteed.

In a further example, the driver circuit comprises a series combination of a first switch and a second switch between outputs of the driver, wherein the first light source is coupled in parallel with the first switch and the second light source is coupled in parallel with the second switch.

Instead of a parallel configuration, the lights sources can also be coupled in series. A first shunt switch is provided across the first switch and a second shunt switch is provided across the second switch.

When the first shunt switch is open and the second shunt switch is closed, the driver provides the first current to the first light source. No current is provided to the second light source. The opening of the first switch and the closing of the second switch can therefore be used at the first discrete dimming level to allow the driver to provide the first current to the first light source and prevent the second current to be provided to the second light source.

When the first shunt switch is closed and the second shunt switch is opened, the driver provides the second current to the second light source. No current is provided to the first light source. The closing of the first switch and the opening of the second switch can therefore be used at the third discrete dimming level to allow the driver to prevent the first current to be provided to the first light source and to provide the second current to the second light source.

When the first shunt switch and the second shunt switch are open, the driver provides the first current to the first light source and the second current to the second light source. The opening of the first switch and the second switch can therefore be used at the second discrete dimming level to allow the driver to provide the first current to the first light source and the second current to the second light source. The first current may be identical to the second current. In this configuration, a current path for the driver is always guaranteed.

When the first light source and the second light source have identical optimum current densities, the controller may regulate that the amplitude of the first current and the second current to be such that they allow the current densities in the light sources to reach to the optimum current densities. This allows the light sources to generate their light at a high efficiency.

In a further example, the controller is arranged to sense a current provided by the driver, wherein the controller is arranged to control the first switch and/or the second switch based on an amplitude of the current provided by the driver.

The controller may be used to control the driver. The discrete dimming level may be translated into a current. The controller may sense the current provided by the driver. The amplitude of the current may be regarded as an indication at what discrete dimming level the light sources are to be operated. If the sensed current is e.g. high, the controller may allow the first current to flow through the first light source and the second current to flow through the second light source. If the sensed current is e.g. relatively low, the controller may allow only the first current to flow through the first light source and prevent any second current to flow through the second light source. It may be regarded that in this situation, the driver does not provide enough current to support the second current and that therefore only the first current is provided.

In a further example, a forward voltage of the first light source is smaller than a forward voltage of the second light source.

It may be that the forward voltage of the first light source differs from the forward voltage of the second light source. This may be because different type of light sources is used such as different LED types. Preferably, the forward voltage of the first light source is smaller than the forward voltage of the second light source such that regardless of the configuration of switches only one of the light sources is active at the first discrete dimming level.

In a further example, at the first discrete dimming level, the driver is arranged to provide the first current to the first light source such that a current density through the first light source allows the first light source to emit light close to the highest efficiency of the first light source.

Preferably, the current to the first light source is of a magnitude such that the first light source is operated with an optimum current density. During the first discrete dimming level the first light source is operated at its optimum efficiency, so the light generated during dimming is generated in an efficient way.

In a further example, at the second discrete dimming level, the driver is arranged to:
provide the first current to the first light source such that a current density through the first light source allows the first light source to emit light close to the highest efficiency of the first light source, and
provide the second current to the second light source such that a current density through the second light source allows the second light source to emit light close to the highest efficiency of the second light source.

Preferably, the current to the first light source is of a magnitude such that the first light source is operated with its optimum current density and the current to the second light source is of a magnitude such that the second light source is operated with its optimum current density. During the second discrete dimming level the first light source and the second light source are operated at their optimum efficiency, so the light generated during this dimming level, which may be full power, is generated in an efficient way.

In a further example, the first light source generates a colour or colour temperature that is different from the colour or colour temperature of the second light source.

Preferably, the first light source and the second light source generate different colors. For example, the first light source may generate a warm white light and the second light source may generate a cold white light, or vice versa. The light sources may also generate light with different colors. The light sources may emit for example red, green or blue light. This allows the colour output of the light sources to vary based on the discrete dimming levels.

In a further example, the lighting device further comprises at least three light sources in a parallel configuration, wherein the number of dimming levels is based on the number of light sources.

Preferably, more discrete dimming levels may be required to allow more dimming steps to be introduced across the entire dimming range. This can be done by introducing additional light sources that can be controlled by the controller to receive their respective currents. These currents can be provided at different discrete dimming levels, e.g. a fourth discrete dimming level. Different combinations of active light sources during different discrete dimming levels allow the light output of the lighting device to vary over all the dimming ranges. Preferably, the discrete dimming levels are set such that they represent a mimicking of a dimming of a conventional incandescent light bulb. This means that when the current to the light sources is lowered, the light sources that generate relatively cold white light are deactivated so that by reducing the current to the light sources, the overall color temperature becomes warmer.

In a further example, light generated by the first light source is emitted at a first surface and light generated by the second light source is emitted at a second surface, wherein the first surface at least partly does not overlap with the second surface.

As an addition or alternative to changing light intensity, color or color temperature of the light sources, a beam shaping mechanism can be introduced. When the first light source emits light at a surface that is different from a surface upon which the second light source emits, the discrete dimming levels can be used for lighting different surfaces. The overall beam angle of a lighting device can be adjusted based on the discrete dimming level.

### BRIEF DESCRIPTION OF THE DRAWINGS

Examples of the invention will now be described with reference to the accompanying drawings, in which:

FIG. 1 shows an example of a circuit diagram of a lighting device.

FIG. 2 shows another example of a circuit diagram of a lighting device.

FIG. 3 shows an example of a graph of a relation between the light source current and the dimming level.

FIG. 4 shows another example of a circuit diagram of a lighting device.

FIG. 5 shows an example of an implementation of a lighting device.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should also be understood that the Figures are merely schematic and are not drawn to scale. It should also be understood that the same reference numerals are used throughout the Figures to indicate the same or similar parts.

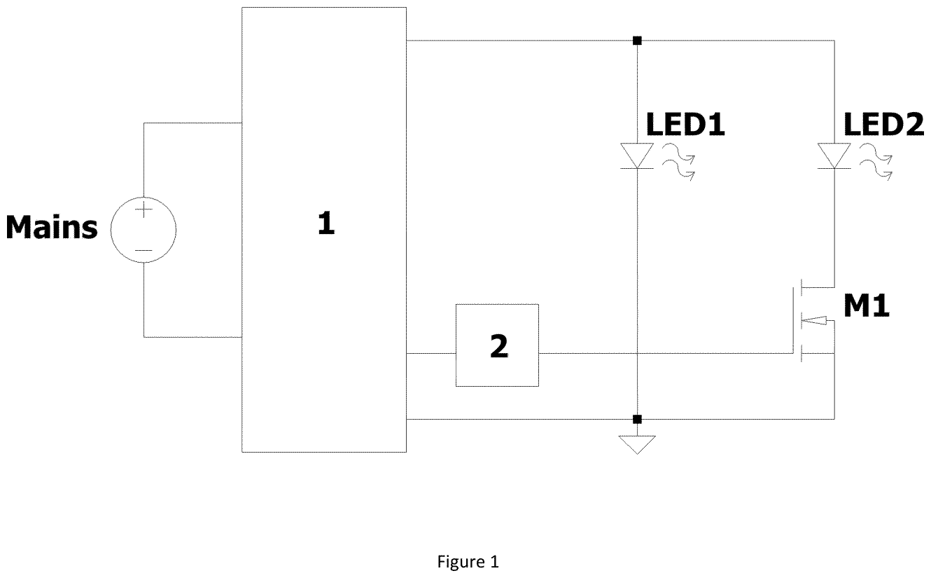

FIG. 1 shows an example of a circuit diagram of a lighting device. The lighting device has a driver circuit. The driver circuit has a driver 1 that is arranged to power a first light source LED1 and a second light source LED2. A first switch M1 is coupled in series with the second light source LED2. The first light source LED1 and the series configuration of the second light source LED2 and the first switch M1 are coupled in parallel to the outputs of the driver 1. The first light source LED1 and the series configuration of the second light source LED2 and the first switch M1 may be coupled in parallel with each other. A controller 2 is provided to control the first switch M1. Preferably, the controller 2 may also be used to control the driver 1. This allows one controller 2 to provide control for both the first switch M1 and the driver 1. Alternatively, the controller 2 comprises multiple components for different purposes, e.g. controlling the first switch M1 separately from the driver 1. The controller 2 may be an integral part of the driver. The driver 1 may be arranged to receive a mains voltage Mains. The mains voltage Mains is an AC voltage and may therefore be rectified by a rectifier circuit. The rectifier circuit may be part of the driver. The controller 2 may receive a dimming signal from an external device that are arranged to provide dimming signals. Examples of dimming signals are phase-cut dimming signals, 0-10 V dimming signals, DALI dimming signals, DMX dimming signals or wireless dimming signals. The controller 2 receives the dimming signal and converts this dimming signal into a discrete dimming level. This means that the controller 2 translates the dimming signal into dimming steps. Preferably, when the first light source LED1 and the second light source LED2 provide a similar light output, the number of dimming steps are based on the number of light sources that are provided. In the example provided, two light sources are provided.

There are at least three discrete dimming steps available. One discrete dimming step can be set at 0% output power, another discrete dimming step may be set at 33% output power, another discrete dimming step may be set at 66% output power and another discrete dimming step may be set at 100% output power. In this case, the driver 1 may be configured to generate no current such that no light source is powered at the dimming step of 0% output power.

At a first discrete dimming level, the driver 1 may provide a current of an amplitude corresponding to the first current. The controller 2 may open the first switch M1, causing the first current to flow through the first light source LED1. In this situation, no current can flow through the second light source LED2. In the first discrete dimming level, the driver circuit provides the first current to the first light source LED1 and no current to the second light source LED2.

At a second discrete dimming level, the driver may provide a current of an amplitude corresponding to a sum of the first current and the second current. The controller 2 may close the first switch M1. This allows the second current to flow through the second light source LED2. Preferably, a forward voltage of the first light source LED1 is approximately identical to a forward voltage of the second light source LED2. In this situation, closing the first switch M1 allows the first current to flow through the first light source LED1 and the second current to flow through the second light source LED2.

The driver 1 may be arranged to regulate the first current such that this will correspond with a current density in the first light source LED1 that allows the first light source LED1 to emit light at very high efficiency, preferably such that the efficiency of the first light source LED1 is maximized. Preferably, the first current has an amplitude that provides a current density in the first light source such that the first light source generates light at a predetermined efficiency. Preferably, the first current allows the first light source to operate at or close to its maximum efficiency. The driver 1 may also be arranged to regulate the second current such that this will correspond with a current density in the second light source LED2 that allows the second light source LED2 to emit light at very high efficiency, preferably such that the efficiency is maximized. Preferably, the second current has an amplitude that provides a current density in the second light source such that the second light source generates light at a predetermined efficiency. Preferably, the second current allows the second light source to operate at or close to its maximum efficiency. In the example where the first light source LED1 has an approximately identical power requirement as the second light source LED2, the first current and the second current may be identical in amplitude. The driver 1 may then be configured to provide only two current levels, namely the first current or the sum of the first current and the second current.

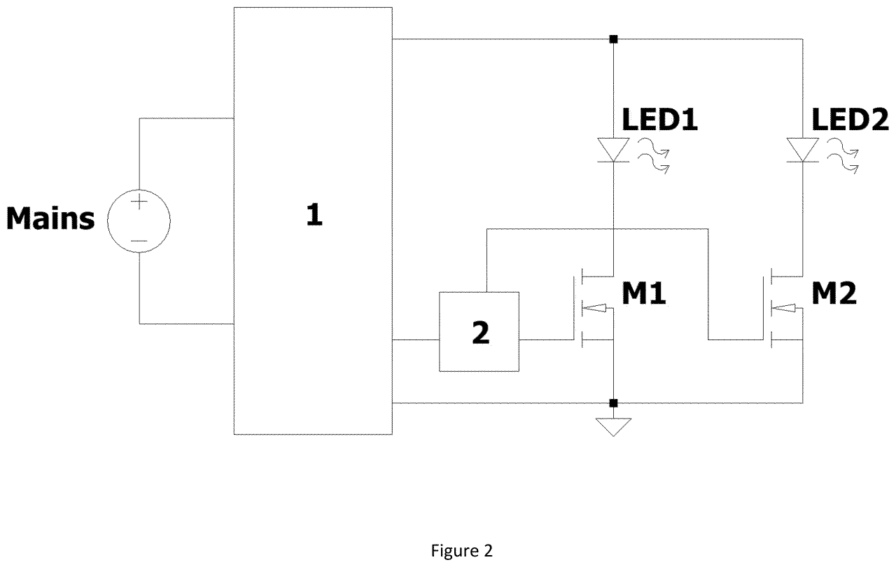

FIG. 2 shows another example of a circuit diagram of a lighting device. The lighting device has a driver circuit. The driver circuit has a driver 1 that is arranged to power a first light source LED1 and a second light source LED2. A first switch M1 is coupled in series with the first light source LED1. A second switch M2 is coupled in series with the second light source LED2. The series configuration of the first light source LED1 with the first switch M1 and the series configuration of the second light source LED2 and the second switch M2 are coupled in parallel to the outputs of the driver 1. The series configuration of the first light source LED1 with the first switch M1 and the series configuration of the second light source LED2 and the second switch M2 may be coupled in parallel with each other. A controller 2 is provided to control the first switch M1 and the second switch M2. Preferably, the controller 2 may also be used to control the driver 1. This allows one controller 2 to provide control for both the first switch M1 and the driver 1. Alternatively, the controller 2 comprises multiple components for different purposes, e.g. controlling the first switch M1 separately from the driver 1. The controller 2 may be an integral part of the driver. The driver 1 may be arranged to receive a mains voltage Mains. The mains voltage Mains is an AC voltage and may therefore be rectified by a rectifier circuit. The rectifier circuit may be part of the driver. The controller 2 may receive a dimming signal from an external device that are arranged to provide dimming signals. Examples of dimming signals are phase-cut dimming signals, 0-10 V dimming signals, DALI dimming signals, DMX dimming signals or wireless dimming signals. The controller 2 receives the dimming signal and converts this dimming signal into a discrete dimming level. This means that the controller 2 translates the dimming signal into dimming steps. Preferably, when the first light source LED1 and the second light source LED2 provide a similar light output, the number of dimming steps are based on the number of light sources that are provided. In the example provided, two light sources are provided. There are three discrete dimming steps available. One discrete dimming step can be set at 0% output power, another discrete dimming step may be set at 33% output power, another discrete dimming step may be set at 66% output power and another discrete dimming step may be set at 100% output power. In this case, the driver 1 may be configured to generate no current such that no light source is powered at the dimming step of 0% output power.

The controller 2 may be arranged to control the first switch M1 and the second switch M2 based on the discrete dimming level. The driver 1 may be arranged to regulate the current to the light sources based of the discrete dimming level. The driver 1 may receive the discrete dimming signal from the controller 2.

At a first discrete dimming level, the controller 2 may close the first switch M1 and open the second switch M2. The driver 1 may then provide a current to the light sources that corresponds to the first current. By closing the first switch M1 and opening the second switch M2, the controller 2 allows the first current to flow through the first light source LED1. The driver 1 determines the amplitude of the first current and therefore determines the current density that is present in the first light source LED1. Preferably, the first current is set to an amplitude that allows the current density in the first light source LED1 to be at its optimum current density to allow the first light source LED1 to emit light at its most efficient way. The first discrete dimming level allows the lighting device to emit light with only the first light source LED1. This means that a relative low light output i.e., a dimmed light output is provided.

At a second discrete dimming level, the controller 2 may close the first switch M1 and close the second switch M2. The driver 1 may then provide a current to the light sources that corresponds to a sum of the first current and the second current. Preferably, the first light source LED1 and the second light source LED2 have identical forward voltages. This allows the current provided by the driver 1 to be distributed among the light sources while no additional regulation is required. In this example, the first current flows through the first light source LED1 and the second current flows through the second light source LED2. Preferably, the current to the first light source LED1 is of a magnitude such that the first light source LED1 is operated with its optimum current density and the current to the second light source LED2 is of a magnitude such that the second light source LED2 is operated with its optimum current density.

At a third discrete diming level, the controller 2 may open the first switch M1 and closes the second switch M2. By opening the first switch M1 and closing the second switch M2, the controller 2 allows the second current to flow through the second light source LED2. The driver 1 determines the amplitude of the second current and therefore determines the current density that is present in the second light source LED2. Preferably, the second current is set to an amplitude that allows the current density in the first light source LED2 to be at its optimum current density to allow the first light source LED2 to emit light at its most efficient way. The third discrete dimming level allows the lighting device to emit light with only the second light source LED2. This means that a relative low light output i.e., a dimmed light output is provided.

In the first discrete dimming level, the first light source LED1 is powered and the second light source LED2 is not powered by the driver 1. In the third discrete dimming level, the first light source LED1 is not powered and the second light source LED2 is powered by the driver 1. In the second discrete dimming level, the first light source LED1 and the second light source LED2 are powered by the driver 1. For dimming purposes, the first discrete dimming level and the second dimming level may be used. The third dimming level may be used to provide different desired effects. The first light source LED1 and the second light source LED2 may have identical forward voltages but may provide e.g. different color temperatures. The first light source LED1 may be an LED that provides a warm white light and the second light source may be an LED that provides a cold white light. The LEDs may be e.g. blue LEDs with a phosphorous layer converting the blue light into warm white light or cold white light. At the first discrete dimming level, the first light source LED1 is powered and therefore, a warm white light is generated by the lighting device at a dimmed light output. At the third discrete dimming level, the second light source LED1 is powered and therefore, a cold white light is generated by the lighting device at a dimmed light output. At the second discrete dimming level, the first light source LED1 and the second light source LED2 are powered. A combination of warm white light and cold white light are generated by the lighting device.

As done by common practice, to provide a dimmed light output, the lower (first) current is provided to two light sources. This causes the current density to drop in both light sources, effectively reducing the efficiencies of both light sources. It is an insight of the inventors that by reducing the current and the number of light sources simultaneously, the current density remains approximately the same, allowing dimming to be performed at a high efficiency.

Preferably, the light output generated by the lighting device is higher at the second discrete dimming level than at the first discrete dimming level.

In the examples provided, two light sources are provided. More light sources may be provided in parallel connection with the first light source LED1 and/or the second light source LED2. These additional light sources may be provided with their own corresponding series connected switch. More light sources may allow more discrete dimming levels to be introduced, which may increase the resolution in dimming steps. The driver 1 may be adapted to provide a corresponding current for each of the discrete dimming levels. The more discrete dimming levels, the more current levels may need to be provided by the driver 1. The driver 1 may therefore be adapted to provide multiple discrete current levels to provide currents to the light sources corresponding to the discrete dimming level.

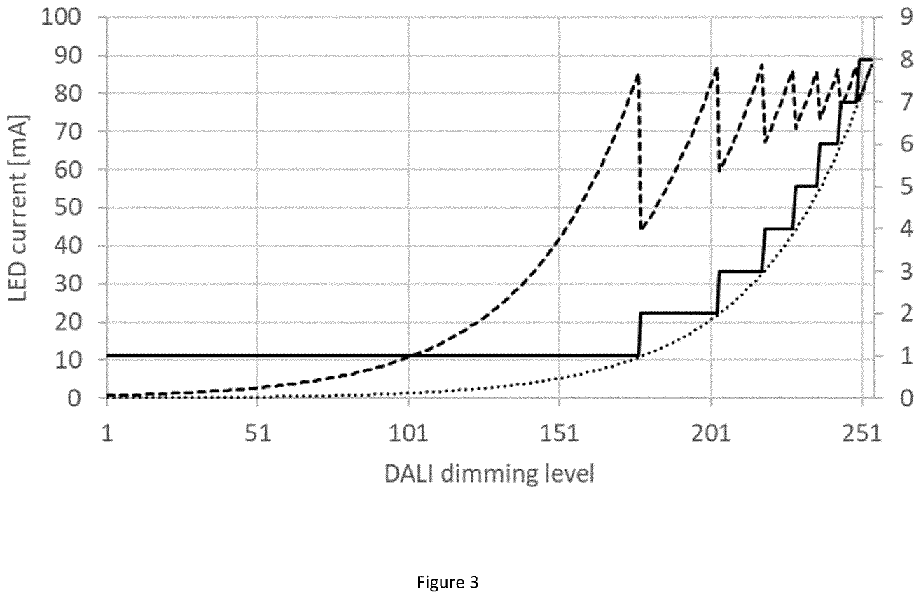

FIG. 3 shows a graph showing the relation between the dimming level and the current through the powered light sources according to another example. In this example, the driver 1 is adapted to provide a current that may be increased based on the dimming level. The driver 1 may increase or decrease the current to the light sources. This may impact the efficiency of the light sources since the variation of the current causes the current density to deviate from the optimum current density. The driver 1 may be arranged to limit the current variation such that not too much efficiency will be lost in the light sources. It is preferred that the current through the light source may not deviate more that 50% from the maximum current provided to the light sources. This means that the current through at least one light source may vary between 100% to 50% of the current.

The discrete dimming levels are used in a different manner as in the previous examples. The discrete dimming levels are used to determine whether an additional light source is required to be activated or if another light source is to be prevented from being powered. The controller 2 determines the discrete dimming levels based on the received dimming level. The controller 2 determines based on the determined discrete dimming level how many light sources are to be activated. In the examples provided, the controller 2 determines which switches are to be closed and which to be opened.

In FIG. 3, eight light sources are used. These eight light sources form eight parallel channels and have preferably approximately identical forward voltages. Preferably they also have approximately identical current requirements. The dimming level is represented as a DALI dimming level ranging from 0 to 253. In this example, the dimming curve is a logarithmic dimming curve. This may provide the benefit that the dimming behavior of the lighting device follows the behavior of the human eye. The human eye has a logarithmic sensitivity to light intensity changes. At a dimming level of 0, the controller 2 may configure no light sources to be connected to the driver 1. No power will be provided to the light sources so the driver 1 may be configured to provide no current to the light sources. Between a dimming level of 1 and 175, a single light source is provided with a current from the driver. The current starts at a minimum current of zero mA and builds up to 85 mA. The dimming level is in this example used by the driver 1 to determine the increasing current to the light source and by the controller 2 to determine how many light sources are to be provided. In this case, the single light source that is active may not be operated at or close to its optimum current density because the current range to this single light source varies from 0 to 85 mA. In order to further optimize the efficiency, a trade off in dimming level could be made. As an example, no current may be provided lower than 42.5 mA (50% of the total current) so that the efficiency of the light source is not impacted too much. However, if the maximum current of 85 mA corresponds to the optimum current density in the active light sources, the impact of reducing the current and therefore the current density in the light source will have a lower impact that e.g. increasing the current and therefore the current density above the optimum current density.

Between a dimming level of 176 and 205, the controller 2 may decide that another discrete dimming level has been reached, and therefore allow an additional light source to be provided with the current from the driver 1. In this example, two light sources may be powered. Since now two, instead of one, light sources receive the current from the driver 1, the current through the light sources will approximately halve as can be seen in the step at the dimming level 176, where the current drops to roughly 45 mA for each light source. The driver 1 however still provides 85 mA. Increasing the dimming level to 205 allows the driver 1 to further increase the currents in the light sources back up to 85 mA. The driver 1 may provide at a dimming level of 205 a total current of 170 mA.

Between a dimming level of 206 and 216, the controller 2 may decide that another discrete dimming level has been reached. In this example, three light sources may be powered. Since now three light sources are powered by the driver 1, the total current provided by the driver 1 is distributed amount the three light sources. The 170 mA will be then result in approximately 57 mA per light source at the dimming level of 206. Increasing the dimming level to 216 allows the driver 1 to further increase the currents in the light sources back up to 85 mA. The driver 1 would then provide 255 mA to all active light sources.

Between a dimming level of 217 and 226, the controller 2 may decide that another discrete dimming level has been reached. In this example, four light sources may be powered. Since now four light sources are powered by the driver 1, the total current provided by the driver 1 is distributed amount the four light sources. The 255 mA will be then result in approximately 64 mA per light source at the dimming level of 217. Increasing the dimming level to 226 allows the driver 1 to further increase the currents in the light sources back up to 85 mA. The driver 1 would then provide 340 mA to all active light sources.

Between a dimming level of 227 and 234, the controller 2 may decide that another discrete dimming level has been reached. In this example, five light sources may be powered. Since now five light sources are powered by the driver 1, the total current provided by the driver 1 is distributed amount the five light sources. The 340 mA will be then result in approximately 68 mA per light source at the dimming level of 227. Increasing the dimming level to 234 allows the driver 1 to further increase the currents in the light sources back up to 85 mA. The driver 1 would then provide 425 mA to all active light sources.

Between a dimming level of 235 and 242, the controller 2 may decide that another discrete dimming level has been reached. In this example, six light sources may be powered. Since now six light sources are powered by the driver 1, the total current provided by the driver 1 is distributed amount the six light sources. The 425 mA will be then result in approximately 71 mA per light source at the dimming level of 235. Increasing the dimming level to 242 allows the driver 1 to further increase the currents in the light sources back up to 85 mA. The driver 1 would then provide 510 mA to all active light sources.

Between a dimming level of 243 and 248, the controller 2 may decide that another discrete dimming level has been reached. In this example, seven light sources may be powered. Since now seven light sources are powered by the driver 1, the total current provided by the driver 1 is distributed amount the seven light sources. The 510 mA will be then result in approximately 73 mA per light source at the dimming level of 243. Increasing the dimming level to 248 allows the driver 1 to further increase the currents in the light sources back up to 85 mA. The driver 1 would then provide 595 mA to all active light sources.

Between a dimming level of 249 and 253, the controller 2 may decide that another discrete dimming level has been reached. In this example, eight light sources may be powered. Since now eight light sources are powered by the driver 1, the total current provided by the driver 1 is distributed amount the eight light sources. The 595 mA will be then result in approximately 74 mA per light source at the dimming level of 249. Increasing the dimming level to 253 allows the driver 1 to further increase the currents in the light sources back up to 85 mA. The driver 1 would then provide 680 mA to all active light sources. At this discrete dimming level, all eight of the light sources are active. At the dimming level of 253, all light sources are provided with 85 mA and therefore, the lighting device will emit the maximum light possible.

In the example provided, eight light sources are used. It is clear that this is merely one example, where other examples may use more or less light sources with preferably at least two light sources.

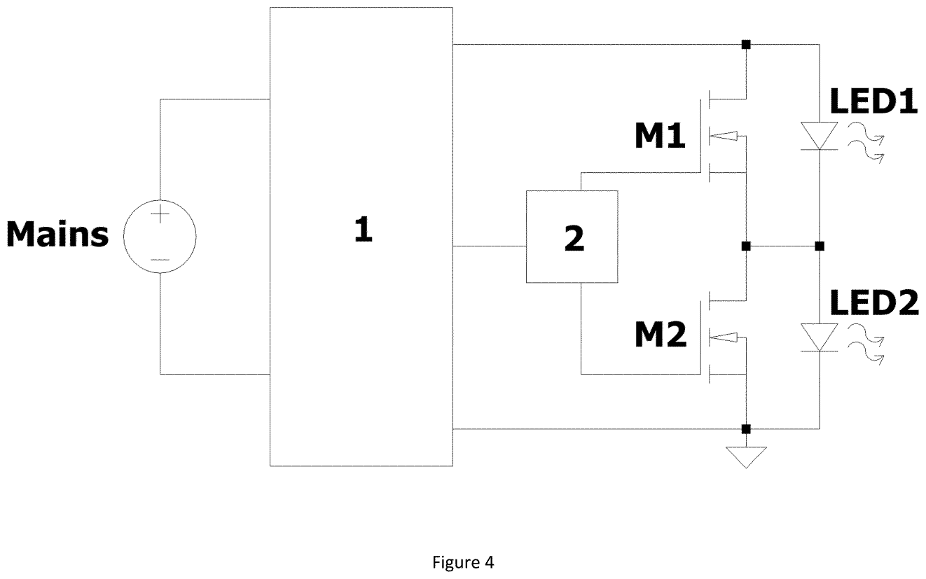

FIG. 4 shows an example of a lighting device. The lighting device has a driver circuit. The driver circuit has a driver 1 that is arranged to power a first light source LED1 and a second light source LED2. The first light source LED1 is coupled in series with the second light source LED2. The series configuration of the first light source LED1 and the second light source LED2 is coupled between outputs of the driver 1. In parallel to the first light source LED1, the first switch M1 is coupled. In parallel to the second light source LED2, the second switch M2 is coupled. The switches may act as shunt switches, when closed effectively shunting the corresponding light source. The driver 1 is arranged to provide a current to the light sources. A controller 2 is provided to control the first switch M1 and the second switch M2. Preferably, the controller 2 may also be used to control the driver 1. This allows one controller 2 to provide control for both the first switch M1 and the driver 1. Alternatively, the controller 2 comprises multiple components for different purposes, e.g. controlling the first switch M1 separately from the driver 1. The controller 2 may be an integral part of the driver. The driver 1 may be arranged to receive a mains voltage Mains.

The mains voltage Mains is an AC voltage and may therefore be rectified by a rectifier circuit. The rectifier circuit may be part of the driver. The controller 2 may receive a dimming signal from an external device that are arranged to provide dimming signals.

Examples of dimming signals are phase-cut dimming signals, 0-10 V dimming signals, DALI dimming signals, DMX dimming signals or wireless dimming signals. The controller 2 receives the dimming signal and converts this dimming signal into a discrete dimming level. This means that the controller 2 translates the dimming signal into dimming steps. Preferably, when the first light source LED1 and the second light source LED2 provide a similar light output, the number of dimming steps are based on the number of light sources that are provided. In the example provided, two light sources are provided. There are three discrete dimming steps available. One discrete dimming step can be set at 0% output power, another discrete dimming step may be set at 33% output power, another discrete dimming step may be set at 66% output power and another discrete dimming step may be set at 100% output power. In this case, the driver 1 may be configured to generate no current such that no light source is powered at the dimming step of 0% output power.

The controller 2 may be arranged to control the first switch M1 and the second switch M2 based on the discrete dimming level. The driver 1 may be arranged to regulate the current to the light sources based of the discrete dimming level. The driver 1 may receive the discrete dimming signal from the controller 2. The teachings provided in the examples where the lights sources are coupled in parallel may also apply to the teachings in this example, where the light sources are coupled in series.

When the first switch M1 is open and the second switch M2 is closed, the driver 1 provides a first current to the first light source LED1. The second light source LED2 is shunted by the second switch M2 and therefore no current flows through the second light source LED2. Opening the first switch M1 and closing the second switch M2 may therefore be implemented at the first discrete dimming level.

When the first switch M1 is open and the second switch M2 is open, the driver 1 provides a first current to the first light source LED1 and a second current to the second light source LED2. The first light source LED1 and the second light source LED2 are not shunted by the first switch M1 and the second switch M2 respectively and therefore current flows through the first light source LED1 and the second light source LED2. Opening the first switch M1 and opening the second switch M2 may therefore be implemented at the second discrete dimming level.

When the first switch M1 is closed and the second switch M2 is opened, the driver 1 provides a second current to the second light source LED2. The first light source LED1 is shunted by the first switch M1 and therefore no current flows through the first light source LED1. Closing the first switch M1 and opening the second switch M2 may therefore be implemented at the third discrete dimming level.

In this example, it may be desired that the first current and the second current are identical.

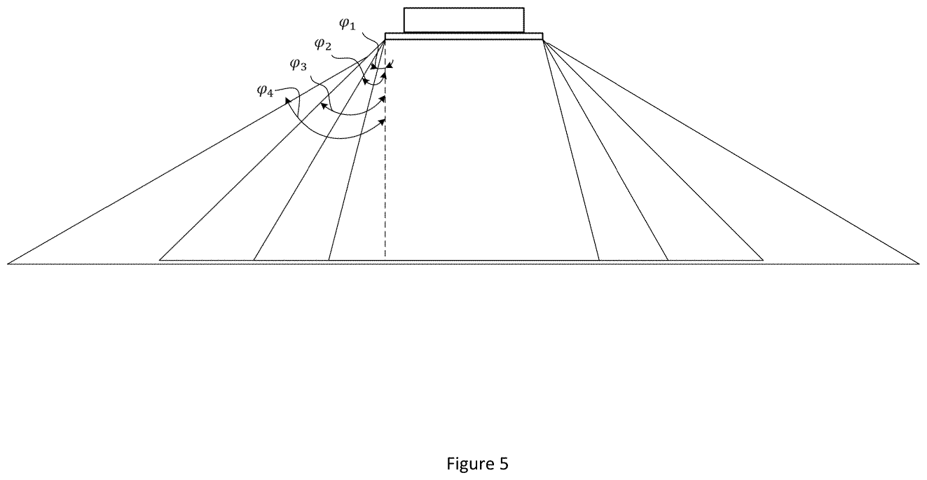

FIG. 5 shows an example of an implementation of a lighting device. The light sources in the lighting device may be provided with their own optics allowing a specific beam angle to be provided. In this example, four beam angles are provided, φ₁, φ₂, φ₃ and φ₄. Each beam angle is generated with a different combination of light sources. In this example, four light sources may be used, each for a corresponding beam angle. Each beam angle may also correspond to a discrete dimming level.

As an example, at a first discrete dimming level, the first light source LED1 may be provided with the first current. This will then result in a light output with a beam angle of φ₁. At a second discrete dimming level, the second light source LED2 may be provided with the second current. This will then result in a light output with a beam angle of φ₂. At a third discrete dimming level, the third light source may be provided with the third current. This will then result in a light output with a beam angle of φ₃. At a fourth discrete dimming level, the fourth light source may be provided with the fourth current. This will then result in a light output with a beam angle of φ₄.

Other combinations are also possible. As an example, at the fourth, third or second discrete dimming levels, all or a part of the other light sources may be powered, resulting in a light output with a beam angle of φ₄, φ₃ or φ₂, but also with an increased light output over the other angles since all or a part of the other light sources are also provided with their corresponding currents. Preferably, the currents provided to the light sources by the driver 1 are of a magnitude that allow the light source to be powered at their optimum current density. The dimming signal may in this example be used to provide different beam angles of the light output of the lighting device in dependence on the discrete diming levels.

Additionally, the dimming signal may be used to change the amount of light generated by the lighting device in dependence on the discrete dimming levels.

In the examples provided, the driver 1 may provide the current to the light source in different ways. In order to keep the current at the level for achieving the optimum current density in the first light source LED1 and/or the second light source LED2 while allowing less light to be emitted by the light sources, the current can be pulse width modulated. The amplitude of the current to light sources is therefore not altered but the average current to the light sources is varied based on the duty cycle of the current. This effectively reduces the light output of the light sources without impacting the efficiency of the light sources. Preferably, the frequency of the PWM current is at a frequency that is above a perceivable frequency for the human eye e.g., 200 Hz. More preferably, the frequency is above 1 kHz.

In the examples provided, the driver may be provided as a switched mode power supply. Examples of switched mode power supplies are boost converters, buck converters, buck-boost converters, flyback converter or resonant converters.

In the examples provided, for the sake of simplicity, the discrete dimming levels may be evenly distributed over the entire dimming range. It is to be understood that this is merely one option of converting the dimming level into discrete dimming levels.

Alternatively, the discrete dimming levels may be distributed such that at a low dimming sub-range, more discrete dimming levels are provided than at a high dimming sub-range, or vice versa.

In the examples provided, the dimming levels may relate linearly with the power required for the light sources. Other relations such as a logarithmic or non-linear may also be conceivable and lead to the desired effects.

As a definition of a dimming level, it is understood how much of the power is required to be provided to the light sources by the driver circuit. At a dimming level of 100%, It is desired that the driver circuit provides 100% of its rated power. At a dimming level of 0%, it is desired that the driver circuit provides 0% of its rated power. The dimming levels in between 100% and 0% can be scaled linear or non-linear to the rated power of the driver circuit. In a linear scaling, a dimming level of 50% may relate to 50% of the rated power of the driver circuit. In a non-linear scaling, a dimming level of 50% may e.g. relate to 25% of the rated power of the driver circuit.

In the examples provided, the controller 2 is arranged to prevent the current to flow to any of the light sources. It is clear that the controller 2 may do this by the use of the switches provided in the examples.

In the examples provided, the first light source LED1 and/or the second light source LED2 may be semiconductor light sources. Examples of semiconductor light sources are LEDs, laser diodes and vertical-cavity surface-emitting lasers, VCSEL. Preferably, the LEDs are formed as a filament.

In the examples provided, the discrete dimming level may be translated in a current amplitude to be generated by the driver 1. The driver 1 generates this current and provides it to the light sources. The controller 2 senses the amplitude of the provided current and determines based on this sensing the amount of light sources that need to be connected to the driver 1 such that the current provided by the driver 1 is properly distributed among the light sources.

In the examples provided, the dimming signal may be a digital signal. The digital signal may e.g. be derived from a DALI signal. When multiple lighting devices are used, the discrete dimming levels for each lighting device will be similar to each other and therefore, the lighting devices receiving the same digital dimming command will therefore generate similar light outputs. When an analog dimming signal is provided, tolerances of electronic components may provide a deviation in light outputs between lighting devices.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A lighting device comprising:
a first light source;
a second light source and
a driver circuit comprising:
a driver adapted to provide a first current to the first light source and a second current to the second light source;
a controller for controlling the driver;
wherein the controller is arranged to receive a dimming signal indicative of a dimming level for a light output of the light sources,
wherein the controller is arranged to convert the received dimming signal into a discrete number of dimming levels, wherein each discrete dimming levels corresponds to an amount of current that is to be provided by the driver to the first light source and/or the second light source, wherein:
at a first discrete dimming level, the controller is arranged to allow the first current to the first light source to be provided and prevents the second current to be provided to the second light source, wherein the first current has an amplitude that provides a current density in the first light source such that the first light source generates light at a predetermined efficiency;
at a second discrete dimming level, the controller is arranged to allow the first current to be provided to the first light source and the second current to be provided to the second light source,
wherein at the first discrete dimming level, the driver is arranged to provide the first current to the first light source such that a current the first light source allows the first light source to emit close to the highest efficiency of the first light source.

2. The lighting device according to claim 1, wherein at a third discrete dimming level, the controller is arranged to prevent the first current to be provided to the first light source and arranged to provide the second current to the second light source.

3. The lighting device according to claim 1, wherein between two discrete dimming steps, the driver (1) is arranged to provide a variable current to only one of the first light source or the second light source based on the dimming signal, while maintaining the current through the other of the first light source or the second light source constant.

4. The lighting device according to claim 1, wherein the second current has an amplitude that provides a current density in the second light source such that the second light source generates light at a predetermined efficiency.

5. The lighting device according to claim 1, wherein the first light source and the second light source coupled in a parallel configuration.

6. The lighting device according to claim 5, wherein the driver circuit comprises a first switch coupled in series with the second light source, wherein the controller is arranged to open and close the first switch and wherein the first current flows through the first light source when the first switch is open and wherein the second current flows through the second light source when the first switch is closed.

7. The lighting device according to claim 1, wherein the driver circuit comprises a first switch coupled in series with the first light source and a second switch coupled in series with the second light source, wherein the controller is arranged to open and close the first switch and the second switch, wherein the first current flows through the first light source when the first switch is closed and wherein the second current flows through the second light source when the second switch is closed.

8. The lighting device according to claim 1, wherein the driver circuit comprises a series combination of a first switch and a second switch between outputs of the driver, wherein the first light source coupled in parallel with the first switch and the second light source is coupled in parallel with the second switch.

9. The lighting device according to claim 6, wherein the controller is arranged to sense a current provided by the driver, wherein the controller is arranged to control the first switch and/or the second switch on an amplitude of the current provided by the driver.

10. The lighting device according to claim 1, wherein a forward voltage of the first light source is smaller than a forward voltage of the second light source.

11. (canceled)

12. The lighting device according to claim 1, wherein at the second discrete dimming level, the driver is arranged to:
provide the first current to the first light source such that a current density through the first light source allows the first light source to emit light close to the highest efficiency of the first light source, and
provide the second current to the second light source such that a current density through the second light source allows the second light source to emit light close to the highest efficiency of the second light source.

13. The lighting device according to claim 1, wherein the first light source generates a colour or colour temperature that is different from the colour or colour temperature of the second light source.

14. The lighting device according to claim 1, further comprising at least three light sources, wherein the number of dimming levels is based on the number of light sources.

15. The lighting device according to claim 1, wherein light generated by the first light source is emitted at a first surface and light generated by the second light source is emitted at a second surface, wherein the first surface at least partly does not overlap with the second surface.
